(19) United States
(12) Patent Application Publication
(10) Pub. No.: US 2024/0027792 A1
(43) Pub. Date: Jan. 25, 2024

(54) GLASSES STRUCTURE

(71) Applicant: GAZELLE CORPORATION, Taipei City (TW)

(72) Inventor: Yu-An LIN, Taipei City (TW)

(21) Appl. No.: 17/869,398

(22) Filed: Jul. 20, 2022

(51) Int. Cl. G02C 5/22

(52) U.S. Cl. CPC G02C 5/22

(57) ABSTRACT

A glasses structure includes a glasses rim, a pivotal rotating component, a rotation lifting component and a temple. The glasses rim has a pivotal connecting part pivotally connected to the pivotal connecting part. The pivotal rotating component has a first positioning hole and a second positioning hole. A latching part and an engaging part are disposed at two ends of the rotation lifting component. The latching part is selectively latched in one of the first positioning hole and the second positioning hole. The temple is correspondingly and pivotally engaged with the engaging part. When the latching part moves from the first positioning hole to the second positioning hole, the end of the temple pivotally engaged with the engaging part is upwardly rotated through the rotation lifting component to move to be above the pivotal rotating component.

### BACKGROUND OF THE DISCLOSURE

### Technical Field

The present disclosure relates to a glasses structure, particularly to a glasses structure capable of being individually worn or being disposed at an outer side of a corrective glasses.

### Description of Related Art

The glasses is commonly used in daily life, and there are mainly two types of glasses, which are a corrective glasses and a non-corrective glasses. The corrective glasses includes a shortsighted glasses, a reading glasses and an astigmatism glasses which are worn by users to correct eye problems. The non-corrective glasses includes a sunglasses, a blue-light filtering glasses and an eye protecting glasses, which are used with respect to different requirements of users and according on certain occasions.

However, a related-art non-corrective glasses is mostly design according to the corrective glasses. When the user desires to wear the corrective glasses and the non-corrective glasses at the same time, the non-corrective glasses is disposed at an outer side of the corrective glasses, thus a temple of the non-corrective glasses is stacked on a temple of the corrective glasses and directly presses the temple of the corrective glasses, thus the user may have uncomfortable feelings at the areas just above the ears at two sides of the head, and may be unable to wear the two glasses for a long time.

Accordingly, the applicant of the present disclosure has devoted himself for improving the mentioned disadvantages.

### SUMMARY OF THE DISCLOSURE

The present disclosure is to provide a glasses structure, in which a temple of the glasses structure is staggeringly arranged relative to a temple of a corrective glasses, and the temple does not directly press on the temple of the corrective glasses to prevent a user from having uncomfortable feelings.

Accordingly, the present disclosure provides a glasses structure, which includes a glasses rim, at least one pivotal rotating component, at least one rotation lifting component and at least one temple. The glasses rim has at least one pivotal connecting part. The pivotal rotating component is pivotally and correspondingly connected to the pivotal connecting part, and has a first positioning hole and a second positioning hole. A latching part and an engaging part are disposed at two ends of the rotation lifting component, and the latching part is selectively latched in one of the first positioning hole and the second positioning hole. An end of the temple is correspondingly and pivotally engaged with the engaging part, wherein when the latching part moves from the first positioning hole to the second positioning hole, the end of the temple pivotally engaged with the engaging part is upwardly rotated through the rotation lifting component to move to be above the pivotal rotating component.

Accordingly, the present disclosure provides a glasses structure, which includes a glasses rim, two pivotal rotating components, two rotation lifting components and two temples. The glasses rim has two pivotal connecting parts. Each of the pivotal rotating components is pivotally and correspondingly connected to each of the pivotal connecting parts, and has a first positioning hole and a second positioning hole. A latching part and an engaging part are disposed at two ends of each of the rotation lifting components, and each of the latching parts is selectively latched in one of each of the first positioning holes and each of the second positioning holes. An end of each of the temples is correspondingly and pivotally engaged with each of the engaging parts, wherein when each of the latching parts correspondingly moves from each of the first positioning holes to each of the second positioning holes, the end of each of the temples pivotally engaged with each of the engaging parts is upwardly rotated through each of the rotation lifting components to move to be above each of the pivotal rotating components.

Advantages achieved by the present disclosure are as follows. A screw bolt is utilized to pass a pivotal hole of the pivotal rotating component to be locked, thus the pivotal rotating component is pivotally and correspondingly connected to the pivotal connecting part. With the first positioning hole communicating with the second positioning hole, the latching part of the rotation lifting component is directly switched between the first positioning hole and the second poisoning hole. The temple is transversally limited and prevented from horizontally moving by an inserting space of an adjusting part covering the left side and the right side of the engaging part of the rotation lifting component. With a fastening hole of the adjusting part being adapted to sheathe a pivotal rotating column of the rotation lifting component, the two are combined and fastened, and the temple may be vertically rotated relative to the rotation lifting component. The temple is fastened at a desired angle through a fastening tooth of a positioning block of the rotation lifting component being correspondingly engaged and fastened with one of the inclined teeth. When the rotation lifting component is being rotated, a stopping slot of the rotation lifting component is used to abut against the pivotal rotating component for a purpose of stopping to prevent the rotation lifting component from over rotating.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective exploded view according to the present disclosure;

FIG. 2 is a perspective view showing the assembly according to the present disclosure;

FIG. 3 is a partially cross sectional view according to the present disclosure;

FIG. 4 is a partial view showing an operating status according to the present disclosure;

FIG. 5 is a partial view showing another operating status according to the present disclosure;

FIG. 6 is a partial view showing one another operating status according to the present disclosure;

FIG. 7 is a perspective view showing an operating status according to the present disclosure; and

FIG. 8 is a schematic view showing the glasses structure being worn according to the present disclosure.

### DETAILED DESCRIPTION OF THE DISCLOSURE

The technical contents of this disclosure will become apparent with the detailed description of embodiments accompanied with the illustration of related drawings as follows. It is intended that the embodiments and drawings disclosed herein are to be considered illustrative rather than restrictive.

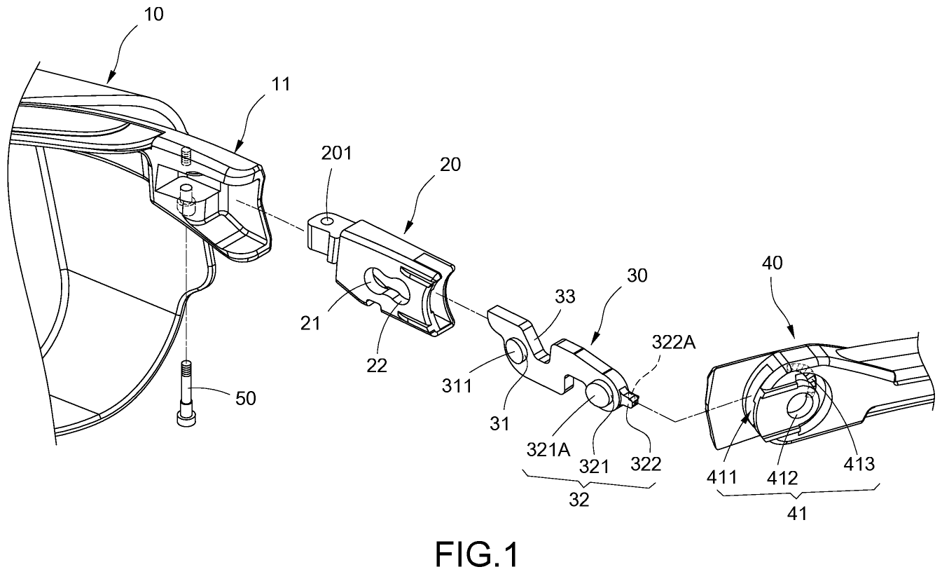

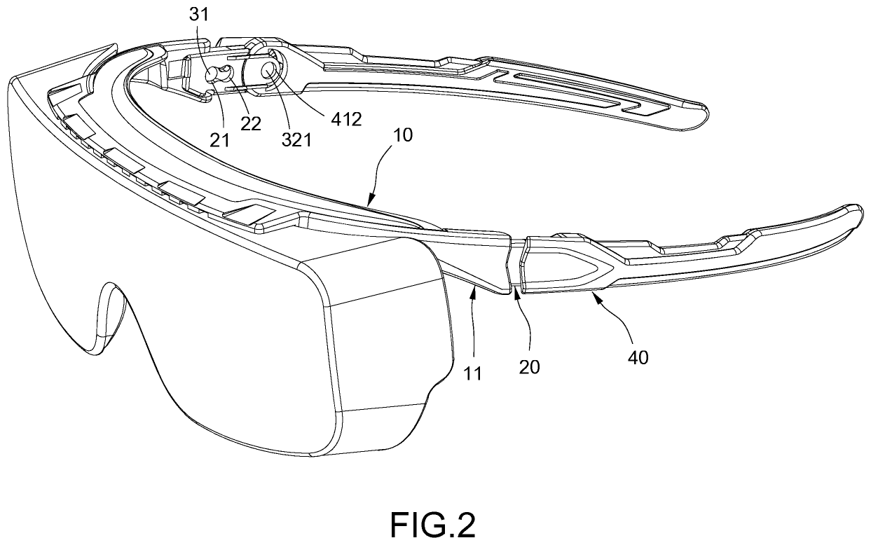

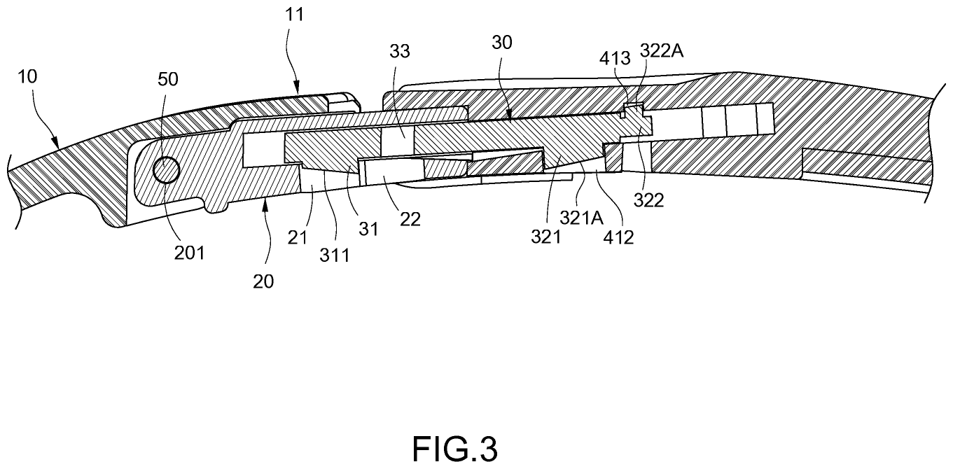

The present disclosure provides a glasses structure, which is used to be individually worn by a user or used to be disposed at an outer side of a corrective glasses A (for example a shortsighted glasses or a reading glasses). Please refer to FIG. 1 to FIG. 7, the glasses structure of the present disclosure mainly includes a glasses rim 10, at least one pivotal rotating component 20, at least one rotation lifting component 30 and at least one temple 40.

The glasses rim 10 has at least one pivotal connecting part 11. The pivotal connecting part 11 is disposed at one side of the glasses rim 10. In some embodiments, the amount of the pivotal connecting part 11, the amount of the pivotal rotating component 20, the amount of the rotation lifting component 30 and the amount of the temple 40 are all two, thus the glasses structure satisfies a wearing habits of general users, but here is not intended to be limiting, for example the amount of the pivotal connecting part 11, the amount of the pivotal rotating component 20, the amount of the rotation lifting component 30 and the amount of the temple 40 may all be one. Details for illustrating each component are provided as follows.

The pivotal rotating component 20 is correspondingly and pivotally connected to the pivotal connecting part 11. In some embodiments, one end of the pivotal rotating component 20 has a pivotal hole 201, and the end of the pivotal rotating component 20 is inserted in the pivotal connecting part 11 and a screw bolt 50 is utilized to pass the pivotal hole 201 and locked in the pivotal connecting part 11. The pivotal connecting manner of the pivotal rotating component 20 and the pivotal connecting part 11 is not limited to FIG. 1. The pivotal rotating component 20 has a first positioning hole 21 and a second positioning hole 22.

A latching part 31 and an engaging part 32 are disposed at two ends of the rotation lifting component 30. The latching part 31 is selectively latched in one of the first positioning hole 21 and the second positioning hole 22. In some embodiments, one end of the rotation lifting component 30, where the latching part 31 is disposed, is inserted in the pivotal rotating component 20, and the pivotal rotating component 20 transversally limits the rotation lifting component 30, thus the latching part 31 correspondingly latches the first positioning hole 21 or the second positioning hole 22. The pivotal rotating component 20 limits two sides of the rotation lifting component 30 to prevent that from being easily released, but here is not intended to be limiting, for example the end of the rotation lifting component 30, where the latching part 31, is disposed may be flatly arranged to be adjacent to one lateral surface of the pivotal rotating component 20, thus the latching part 31 latches the first positioning hole 21 or the second positioning hole 22 to make the two mutually connected. In some embodiments, the latching part 31 is a round protrusion, the first positioning hole 21 and the second positioning hole 22 are both round holes, but here is not intended to be limiting. In some embodiments, the round protrusion of the latching part 31 has a guiding inclined surface 311 facing the pivotal connecting part 11, thus the latching part 31 may be easily to be latched in the second positioning hole 22 when the rotation lifting component 30 is assembled with the pivotal rotating component 20.

One end of the temple 40 is correspondingly and pivotally engaged with the engaging part 32. As such, when the user desires to individually wear the glasses structure of the present disclosure, the temple 40 may be rotated and adjusted relative to the engaging part 32 till a comfortable wearing angle is obtained to make the user feel comfortably wear. Moreover, the glasses structure of the present disclosure is prevented from being fallen or loosened when the glasses structure is individually worn.

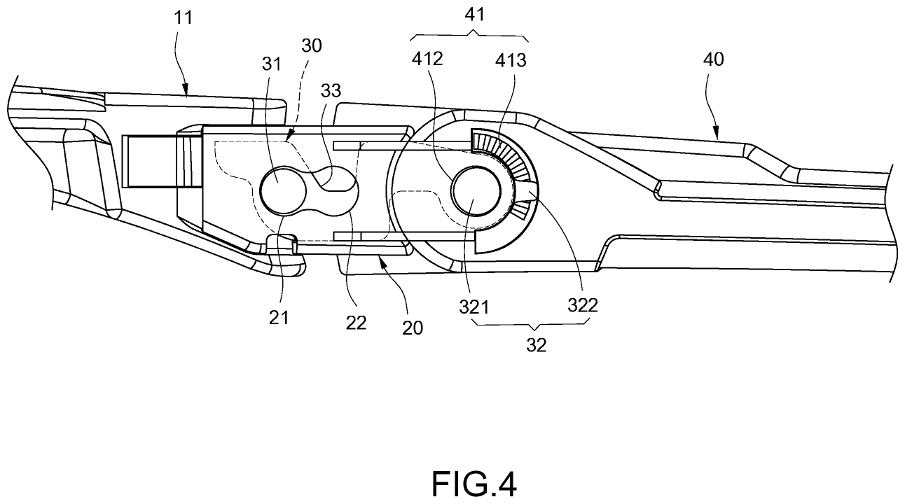

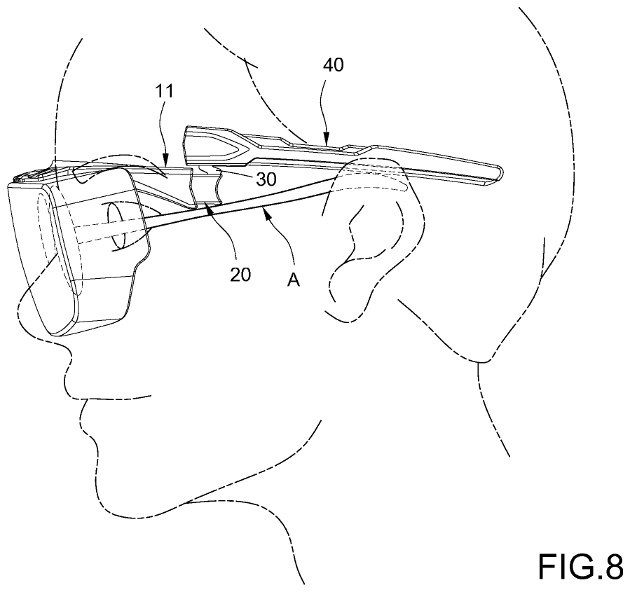

Please refer from FIG. 4 to FIG. 7, when the latching part 31 of the rotation lifting component 3 moves from the first positioning hole 21 to the second positioning hole 22, one end of the temple 40 pivotally engaged with the engaging part 32 is upwardly rotated through the rotation lifting component 30 to move to be above the pivotal rotating component 2 and is deviated from the original location. As such, the temple 40 of the glasses structure of the present disclosure is staggeringly arranged relative to a temple of the corrective glasses A, and the temple 40 does not directly press on the temple of the corrective glasses A to prevent the user from having uncomfortable feelings, as shown in FIG. 8.

Details are provided as follows. In some embodiments, the first positioning hole 21 communicates with the second positioning hole 22, thus the latching part 31 of the rotation lifting component 30 may be directly switched between the first positioning hole 21 and the second poisoning hole 22, but here is not intended to be limiting, for example when the end of the rotation lifting component 30, where the latching part 31 is disposed, is flatly arranged to be adjacent to the lateral surface of the pivotal rotating component 20, the rotation lifting component 30 may be detachably to make the latching part 31 be latched in the first positioning hole 21 or the second positioning hole 22. The first positioning hole 21 is disposed between the pivotal connecting part 11 and the second positioning hole 22. In some embodiments, the first positioning hole 21 and the second positioning hole 22 are horizontally arranged, thus the user horizontally pull the rotation lifting component 30 when switching the rotation lifting component 30, but here is not intended to be limiting, for example the first positioning hole 21 and the second positioning hole 22 may be vertically arranged, and the user vertically pull the rotation lifting component 30 when switching the rotation lifting component 30. As such, the design may be correspondingly adjusted with respect to the operation requirements of the user. In some embodiment, the horizontal arrangement is to increase the visual appearance, because the vertical arrangement may cause the pivotal rotating component 20 over protruding from the pivotal connecting part 11.

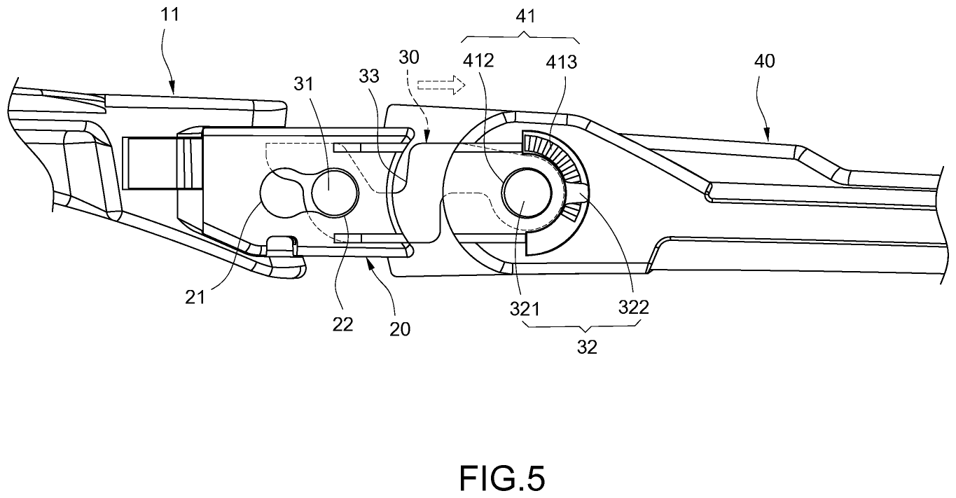

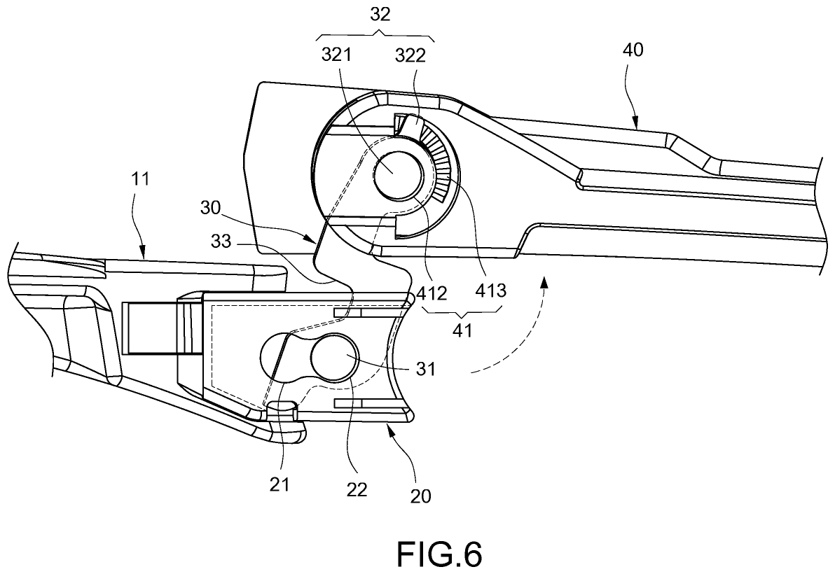

Please refer to FIG. 1, FIG. 5 and FIG. 6, the end of the temple 40 engaged with the engaging part 32 is disposed with an adjusting part 41. The adjusting part 41 has an inserting space 411 and a fastening hole 412 communicating with the inserting space 411, and an inner wall of the adjusting part 411 is disposed with a plurality of inclined teeth 413 surrounding the fastening hole 412 equidistantly and arranged on one lateral surface of the inserting space 411. The engaging part 32 of the rotation lifting component 30 is accommodated in the inserting space 411 and pivotally connected to the adjusting part 411. The engaging part 32 has a pivotal rotating column 321 and a positioning block 322. The fastening hole 412 is adapted to rotatably sheathe the pivotal rotating column 321, thus the temple 40 is vertically rotated relative to the rotation lifting component 30. In some embodiments, the pivotal rotating column 321 has a guiding inclined surface 321A facing the temple 40, thus the pivotal rotating column 321 may be easily inserted in the fastening hole 412 when the rotation lifting component 30 is assembled in the adjusting part 41. The positioning block 322 has a fastening tooth 322A corresponding to one side of each of the inclined teeth 413, the fastening tooth 322A is selectively engaged and fastened with one of the corresponding inclined teeth 413, thus the temple 40 is fastened at a desired angle. As such, the temple 40 is transversally limited and prevented from horizontally moving by the inserting space 411 of the adjusting part 41 covering the left side and the right side of the engaging part 32 of the rotation lifting component 30. With the fastening hole 412 of the adjusting part 41 sheathing the pivotal rotating column 321 of the rotation lifting component 30, the two are combined and fastened, and the temple 40 is being vertically rotated relative to the rotation lifting component 30. The temple 40 is fastened at a desired angle through the fastening tooth 322A of the positioning block 322 of the rotation lifting component 30 being correspondingly engaged and fastened with one of the inclined teeth 413.

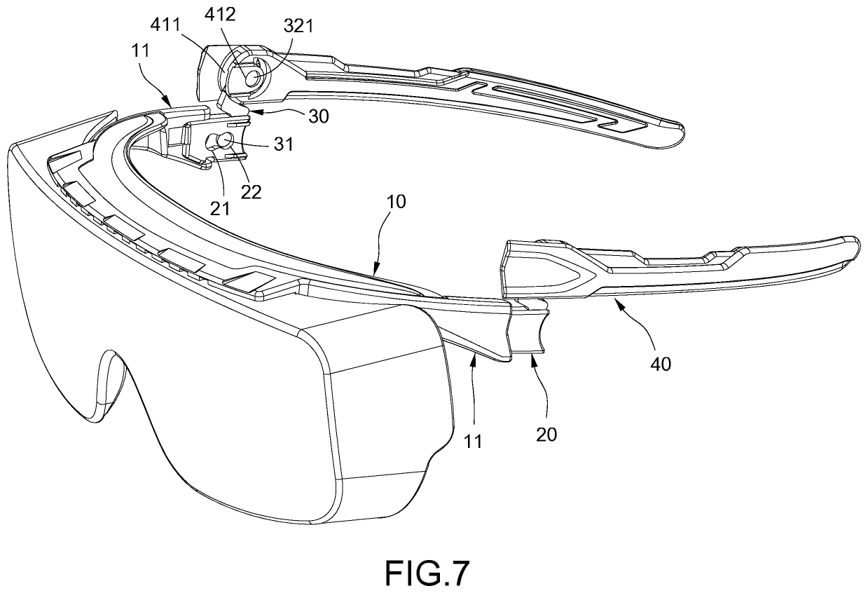

Please refer to FIG. 1, FIG. 6 and FIG. 7, the rotation lifting component 30 is further disposed with a stopping slot 33. When the rotation lifting component 30 is rotating, the stopping slot 33 is used to abut against the pivotal rotating component 20 for a purpose of stopping to prevent the rotation lifting component 30 from over rotating. In some embodiments, the stopping slot 33 is located between the latching part 31 and the engaging part 32, and is formed on a top surface of the rotation lifting component 30. As such, when the latching part 31 of the rotation lifting component 30 moves from the first positioning hole 21 to the second positioning hole 22, the rotation lifting component 30 upwardly rotates until the stopping slot 33 abuts against the top end of the pivotal rotating component 20, thus the problems of too much or too less rotating angle may be avoided. Accordingly, the designer may adjust the depth of the stopping slot 33 according to different operation needs.

While this disclosure has been described by means of specific embodiments, numerous modifications and variations could be made thereto by those skilled in the art without departing from the scope and spirit of this disclosure set forth in the claims.

What is claimed is:

1. A glasses structure, comprising:
a glasses rim, comprising at least one pivotal connecting part;
at least one pivotal rotating component, pivotally connected to the pivotal connecting part, and comprising a first positioning hole and a second positioning hole;
at least one rotation lifting component, comprising a latching part and an engaging part disposed at two ends thereof, wherein the latching part is selectively latched in one of the first positioning hole and the second positioning hole; and
at least one temple, comprising an end pivotally engaged with the engaging part;
wherein, when the latching part moves from the first positioning hole to the second positioning hole, the end of the temple pivotally engaged with the engaging part is upwardly rotated through the rotation lifting component to move to be above the pivotal rotating component.

2. The glasses structure according to claim 1, wherein the first positioning hole communicates with the second positioning hole.

3. The glasses structure according to claim 1, wherein the first positioning hole is located between the pivotal connecting part and the second positioning hole.

4. The glasses structure according to claim 1, wherein the rotation lifting component further comprises a stopping slot, and the stopping slot is located between the latching part and the engaging part and abuts against the pivotal rotating component.

5. The glasses structure according to claim 1, the temple comprises an adjusting part, the adjusting part comprises an inserting space, and the engaging part is accommodated in the inserting space and pivotally connected to the adjusting part.

6. The glasses structure according to claim 5, wherein the engaging part comprises a pivotal rotating column, the adjusting part comprises a fastening hole defined on one side thereof and communicating with the inserting space, and the fastening hole is adapted to rotatably sheathe the pivotal rotating column.

7. The glasses structure according to claim 6, wherein the engaging part further comprises a positioning block, the adjusting part comprises a plurality of inclined teeth surrounding the fastening hole equidistantly and disposed on an inner wall thereof in the inserting space, the positioning block comprises a fastening tooth corresponding to each of the inclined teeth, and the fastening tooth is selectively engaged and fastened with one of the inclined teeth.

8. The glasses structure according to claim 1, wherein one end of the rotation lifting component, where the latching part is disposed, is inserted in the pivotal rotating component, and the pivotal rotating component is configured to transversally limit the rotation lifting component.

9. The glasses structure to claim 1, further comprising a screw bolt, one end of the pivotal rotating component inserted in the pivotal connecting part, and the screw bolt passing the pivotal rotating component and locked in the pivotal connecting part.

10. A glasses structure, comprising:
a glasses rim, comprising two pivotal connecting parts;
two pivotal rotating components, pivotally and correspondingly connected to the pivotal connecting parts, and respectively comprising a first positioning hole and a second positioning hole;
two the rotation lifting components, respectively comprising a latching part and an engaging part disposed at two ends thereof, wherein each of the latching parts is selectively latched in one of each of the first positioning holes and each of the second positioning holes; and
two temples, respectively comprising an end pivotally engaged with each of the engaging parts;
wherein, when each of the latching parts correspondingly moves from each of the first positioning holes to each of the second positioning holes, the end of each of the temples pivotally engaged with each of the engaging parts is upwardly rotated through each of the rotation lifting components to move to be above each of the pivotal rotating components.
